(19) United States
(12) Patent Application Publication
(10) Pub. No.: US 2011/0227504 A1
(43) Pub. Date: Sep. 22, 2011

(54) DRIVER FOR LIGHT EMITTING DIODES

(75) Inventors: Hyo Young KIM, Suwon (KR); Sung Hun OH, Suwon (KR); Doo Ho YOO, Ulsan (KR)

(73) Assignee: SAMSUNG ELECTRO-MECHANICS CO., LTD., Suwon (KR)

(21) Appl. No.: 13/026,401

(22) Filed: Feb. 14, 2011

(30) Foreign Application Priority Data
Mar. 22, 2010 (KR) 10-2010-0025229

(51) Int. Cl. H05B 37/02

(52) U.S. Cl. 315/294

(57) ABSTRACT

A driver for light emitting diodes can reduce heat generation in a switching device by dividing surplus voltage from a plurality of LED arrays, caused by a voltage difference between LEDs, and providing the divided voltage to a plurality of switching devices. The LED driver includes a power part supplying a preset driving voltage to a plurality of LED arrays, and a plurality of driving parts switching a driving voltage flowing to the plurality of LED arrays, respectively. The plurality of driving parts each include a plurality of switches each receiving a divided surplus voltage remaining after the driving voltage is applied to the plurality of LED arrays.

### CROSS-REFERENCE TO RELATED APPLICATIONS

This application claims the priority of Korean Patent Application No. 10-2010-25229 filed on Mar. 22, 2010, in the Korean Intellectual Property Office, the disclosure of which is incorporated herein by reference.

### BACKGROUND OF THE INVENTION

1. Field of the Invention

The present invention relates to a driver for light emitting diodes (LED), and more particularly, to a driver for LEDs, capable of reducing heat generation in a switching device by dividing surplus voltage from a plurality of LED arrays, caused by a voltage difference between LEDs, and providing the divided voltage to a plurality of switching devices.

2. Description of the Related Art

With the advent of the information age, the demand for high-performance displays, capable of displaying information in various forms such as images, graphs and characters, is rapidly increasing so as to realize the quick and efficient transfer of information. In response, the display industry is growing rapidly.

In particular, liquid crystal displays (LCD) have made considerable progress in recent years as next generation high-tech display devices due to their lower power consumption, lesser thickness and lighter weight, as compared to cathode ray tubes. Such liquid crystal displays are currently in widespread use for electronic watches, electronic calculators, computers, televisions and the like.

A liquid crystal display device includes a liquid crystal panel displaying an image and a backlight unit supplying light to the liquid crystal panel.

The liquid crystal panel includes a thin film transistor substrate including a gate line, a data line, a thin film transistor, a pixel electrode and the like, and a color filter substrate including a common electrode and the like. The liquid crystal panel, when receiving a pixel voltage, displays an image by driving liquid crystals in such a manner as to control the transmittance of light supplied from the backlight unit.

The backlight unit utilizes a fluorescent lamp, a light emitting diode (LED) or the like. Of late, an LED has come into widespread use as a backlight unit due to its low power consumption and high color reproducibility.

A plurality of LED arrays, each having a plurality of LEDs connected in series, are employed as the light source of a backlight unit. Here, an operating voltage may vary between the LEDs.

This variation in voltage may be insignificant in a single LED. However, a plurality of LED arrays, each array of which having a plurality of LEDs connected in series, may experience significant variations in voltage between the LED arrays thereof.

When the plurality of LED arrays are connected in parallel, driving power is supplied according to the highest driving voltage among those of the LED arrays. In this case, the same level of driving power is supplied even to an LED array having a relatively low driving voltage. As a result, surplus voltage caused by the variations in voltage is applied to a switching device that drives the LED arrays, thereby causing defects associated with the heat generation of the switching device.

In order to overcome the above defects, a heat sink may be used, which may, however, cause other limitations such as high manufacturing costs.

### SUMMARY OF THE INVENTION

An aspect of the present invention provides a driver for light emitting diodes capable of reducing heat generation in a switching device by dividing surplus voltage from a plurality of LED arrays, caused by a voltage difference between LEDs, and providing the divided voltage to a plurality of switching devices.

According to an aspect of the present invention, there is provided a driver for light emitting diodes (LED), the driver including: a power part supplying a preset driving voltage to a plurality of LED arrays; and a plurality of driving parts switching a driving voltage flowing to the plurality of LED arrays, respectively. The plurality of driving parts each include a plurality of switches each receiving a divided surplus voltage remaining after the driving voltage is applied to the plurality of LED arrays.

Each of the plurality of driving parts may include: a switch portion including at least first and second switches connected in series between the LED array and a ground; a detection resistor connected between the switch portion and the ground and detecting a voltage; a comparator comparing a preset reference voltage to the voltage detected by the detection resistor and sending a switching signal; and a transfer resistor group including a first transfer resistor and a second transfer resistor respectively transferring the switching signal from the comparator to the first and second switches of the switch portion according to a preset resistance ratio.

The first switch may be configured as a first NPN transistor including a collector connected to the LED array, a base connected to the first transfer resistor and receiving the switching signal, and an emitter connected to the second switch. The second switch may be configured as a second NPN transistor including a collector connected to the emitter of the first NPN transistor, a base connected to the second transfer resistor and receiving the switching signal, and an emitter connected to the ground.

A pull-up resistor may be connected between the collector and the base of the first NPN transistor, and send the surplus voltage from the LED array to the base according to a preset resistance value.

The switch portion may include a plurality of NPN transistors connected between the LED array and the ground. The transfer resistor group may include a plurality of transfer resistors respectively corresponding to the plurality of NPN transistors, and send the switching signal from the comparator to the respective base of the plurality of NPN transistors.

The driving part may further include a plurality of pull-up resistors respectively connected to a base and a collector of the plurality of NPN transistors, with the exception of a single NPN transistor placed adjacent to the ground.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating the configuration of a driver for LEDs according to an exemplary embodiment of the invention;

FIG. 2 is a graph showing the electric characteristics of a driver for LEDs according to an exemplary embodiment of the invention; and

FIG. 3 is a schematic view illustrating the configuration of a driving part employed in a driver for LEDs, according to an exemplary embodiment of the invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

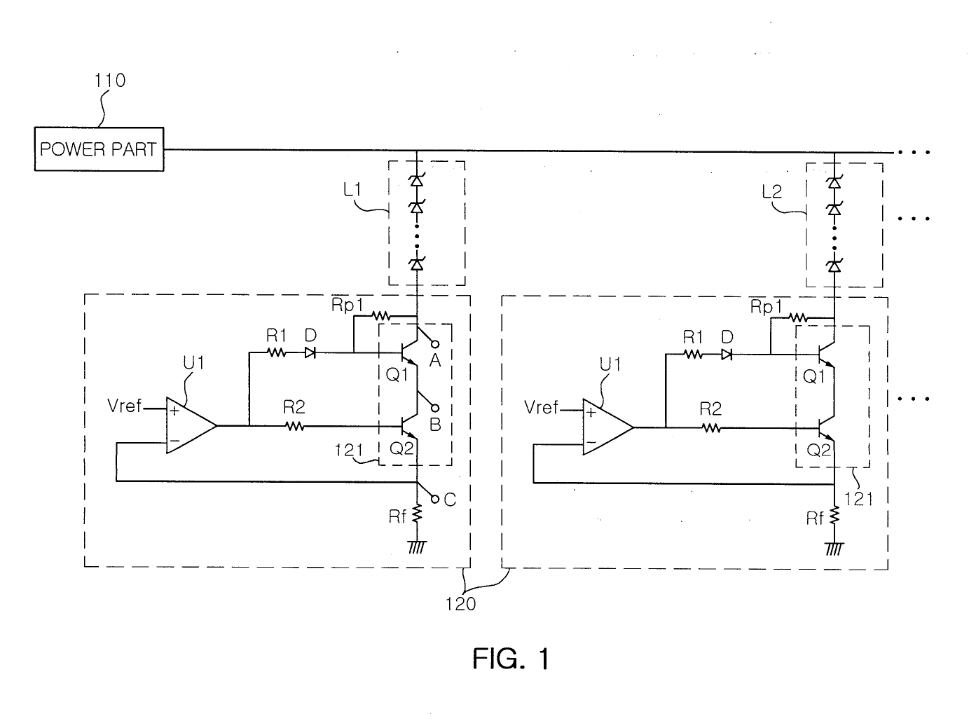

FIG. 1 is a schematic view illustrating the configuration of a driver for LEDs according to an exemplary embodiment of the invention.

Referring to FIG. 1; a driver 100 for LEDs, according to this exemplary embodiment, may include a power part 100 and a plurality of driving parts 120.

The power part 110 may provide a driving voltage having a preset voltage level to a plurality of LED arrays L1 and L2.

In each of the LED arrays L1 and L2, a plurality of LEDs may be connected in series and may each have a different driving voltage. For example, one LED may be driven by 2.7 V, while another LED may be driven by 2.8 V or 2.6 V.

Considering such variations in voltage, the power part 110 may provide a driving voltage with reference to the highest voltage level of the driving voltages of the plurality of LED arrays L1 and L2.

The plurality of driving parts 120 may each include a switch portion 121, a detection resistor Rf, a comparator U1, and a transfer resistor group R1 and R2.

The switch portion 121 may include at least first and second switches Q1 and Q2. The first and second switches Q1 and Q2 may be connected in series between the LED array and the ground. The first and second switches Q1 and Q2 may be configured as first and second NPN transistors, respectively.

The detection resistor Rf may be electrically connected between the switch portion 121 and the ground. Accordingly, surplus voltage, remaining after the driving voltage from the power part 110 is applied to the LED arrays L1 and L2, may be distributed to the first and second NPN transistors Q1 and Q2 of the switch portion 121.

The comparator U1 compares a voltage level detected by the detection resistor Rf to the voltage level of a preset reference voltage Vref, and transfers a switching signal to the first and second NPN transistors Q1 and Q2 accordingly.

The transfer resistor group R1 and R2 may include first and second transfer resistors R1 and R2. The first transfer resistor R1 may transfer a switching signal from the comparator U1 to the first NPN transistor Q1, while the second transfer resistor R2 may transfer a switching signal from the comparator U1 to the second NPN transistor Q2. The first transfer resistor R1 and the second transfer resistor R2 may have a preset resistance ratio.

The first NPN transistor Q1 may have a collector connected to the LED arrays L1 and L2, a base connected to the first transfer resistor R1 and receiving a switching signal, and an emitter connected to a collector of the second NPN transistor Q2. The second NPN transistor Q2 may have a collector connected to the emitter of the first NPN transistor Q1, a base connected to the second transfer resistor R2 and receiving a switching signal, and an emitter connected to the ground.

The NPN transistor conducts to a different extent according to a voltage applied to its base. Thus, surplus voltages, applied to the first and second NPN transistors Q1 and Q2, may be different from each other. Therefore, the first and second transfer resistors Q1 and Q2 form a preset resistance ratio so as to regulate the surplus voltages, respectively applied to the first and second NPN transistors Q1 and Q2.

The resistance ratio, once set between the first and second transfer resistors R1 and R2, is fixed and is not easy to change afterwards. However, driving voltage may vary between LEDs. Thus, not only the first LED array L1 and the second LED array L2 but also each of a plurality of LED arrays may have different driving voltages. Accordingly, there is a need to equalize the surplus voltages applied to the first and second NPN transistors Q1 and Q2 due to the different driving voltages of the plurality of LED arrays.

Accordingly, a pull-up resistor (Rp1) may be connected between the collector and the base of the first NPN transistor Q1. That is, the pull-up resistor Rp1 may drop surplus voltage from a corresponding LED array through its resistance value, and apply the dropped voltage to the base of the first NPN transistor Q1. An extent to which an NPN transistor conducts is varied by the voltage applied to a base thereto. In this regard, the voltage level of the surplus voltage divided and provided to the first NPN transistor Q1 by the voltage applied to the base by the pull-up resistor Rp1 may be varied according to the voltage level of the surplus voltage from the LED array. Also, the voltage level of the surplus voltage divided and provided to the second NPN transistor may be varied accordingly.

That is, the surplus voltage from a corresponding LED array is divided and provided to the first and second NPN transistors Q1 and Q2 according to the resistance ratio between the first and second transfer resistors R1 and R2. Since the resistance ratio of the first and second transfer resistors R1 and R2 is fixed, the higher the surplus voltage from the LED array is, the more surplus voltage is applied to the first NPN transistor Q1. Thus, by using the pull-up resistor Rp1, the voltage levels of the surplus voltage from the LED array, distributed to the first and second NPN transistors Q1 and Q2, may be regulated to be equalized.

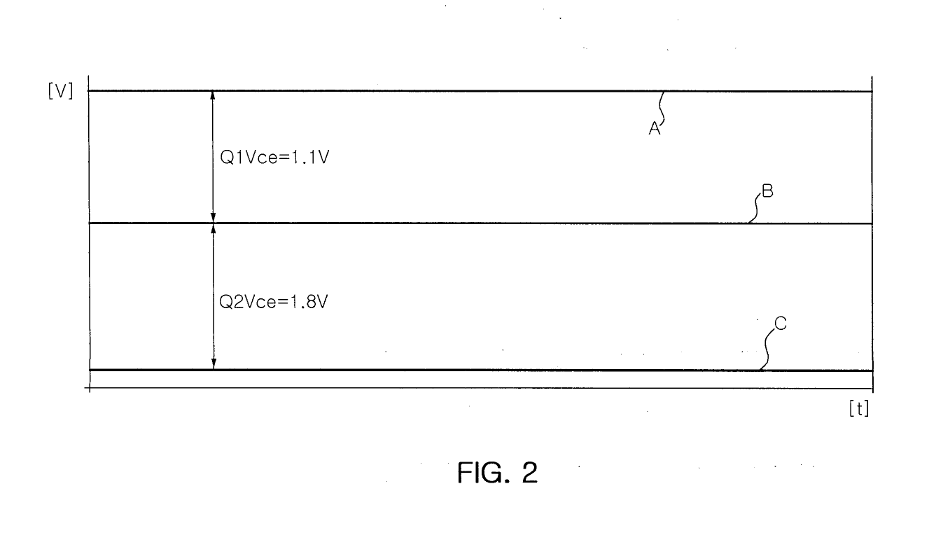

FIG. 2 is a graph illustrating the electrical characteristics of a driver for LEDs according to an exemplary embodiment of the present invention.

Referring to FIGS. 1 and 2, it can be seen that surplus voltage is applied to the first NPN transistor Q1, the second NPN transistor Q2 and the detection resistor Rf.

In FIG. 2, ‘A’ denotes a voltage applied to the collector of the first NPN transistor Q1, ‘B’ denotes a voltage applied to the collector of the second NPN transistor Q2, and ‘C’ denotes a voltage applied to the detection resistor Rf. Referring to this graph, it can be seen that surplus voltage is applied not only to the first NPN transistor Q1, but to both the first and second NPN transistors Q1 and Q2. Accordingly, the heat generated by the surplus voltage may be divided to the first and second NPN transistors Q1 and Q2 at the time of switching.

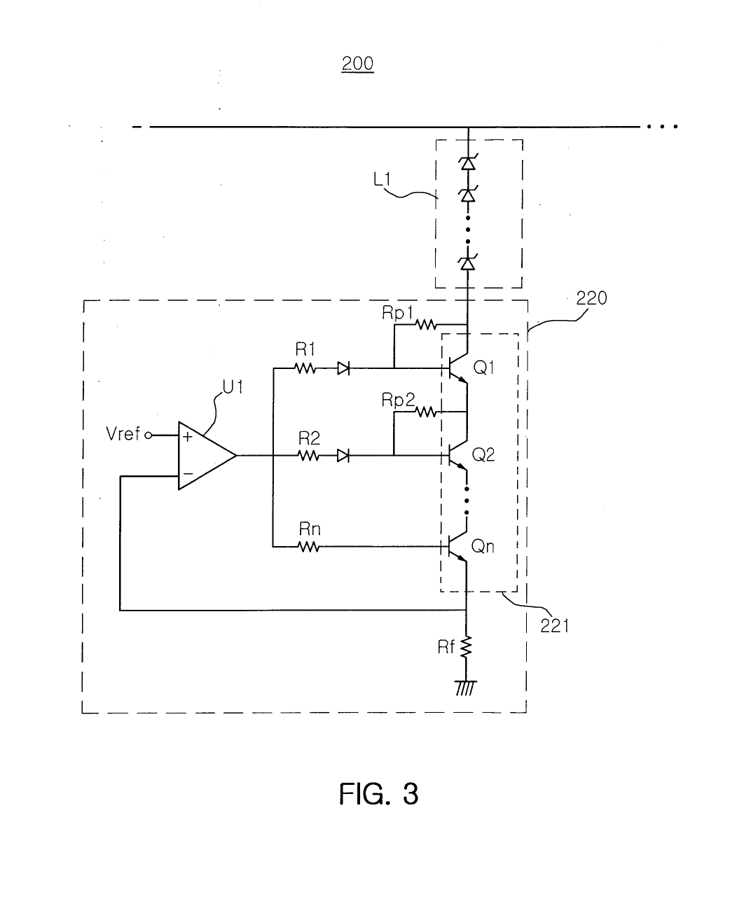

FIG. 3 is a schematic view illustrating the configuration of a driving part employed in a driver for LEDs, according to another exemplary embodiment of the present invention.

Referring to FIG. 3, a driver, employed in a driver 200 for LEDs, according to this exemplary embodiment, may include a plurality of transistors Q1 to Qn connected in series between an LED array L1 and the ground. The LED array L1 may include a plurality of LEDs connected in parallel as shown in FIG. 1. Accordingly, a plurality of driving parts' 220 may be provided so as to be connected to a plurality of LED arrays, respectively.

As described above, the surplus voltage from the LED array L1 is distributed to the plurality of transistors Q1 to Qn, thereby reducing heat generation during the switching of the transistor. Furthermore, a pull-up resistor (Rp1 and Rp2) is connected between the collector and the base of each of the transistors, except for the last transistor Qn, so that the surplus voltage can be more evenly divided and provided to the transistors.

As set forth above, according to exemplary embodiments of the invention, the driver for light emitting diodes can reduce heat generation in a switching device by dividing surplus voltage from a plurality of LED arrays, caused by a voltage difference between LEDs, and providing the divided voltage to a plurality of switching devices.

While the present invention has been shown and described in connection with the exemplary embodiments, it will be apparent to those skilled in the art that modifications and variations can be made without departing from the spirit and scope of the invention as defined by the appended claims.

What is claimed is:

1. A driver for light emitting diodes (LED), the driver comprising:
a power part supplying a preset driving voltage to a plurality of LED arrays; and
a plurality of driving parts switching a driving voltage flowing to the plurality of LED arrays, respectively;
wherein the plurality of driving parts each include a plurality of switches each receiving a divided surplus voltage remaining after the driving voltage is applied to the plurality of LED arrays.

2. The driver of claim 1, wherein each of the plurality of driving parts comprises:
a switch portion comprising at least first and second switches connected in series between the LED array and a ground;
a detection resistor connected between the switch portion and the ground and detecting a voltage;
a comparator comparing a preset reference voltage to the voltage detected by the detection resistor and sending a switching signal; and
a transfer resistor group comprising a first transfer resistor and a second transfer resistor respectively transferring the switching signal from the comparator to the first and second switches of the switch portion according to a preset resistance ratio.

3. The driver of claim 2, wherein the first switch is configured as a first NPN transistor comprising a collector connected to the LED array, a base connected to the first transfer resistor and receiving the switching signal, and an emitter connected to the second switch; and
the second switch is configured as a second NPN transistor comprising a collector connected to the emitter of the first NPN transistor, a base connected to the second transfer resistor and receiving the switching signal, and an emitter connected to the ground.

4. The driver of claim 3, wherein a pull-up resistor is connected between the collector and the base of the first NPN transistor, and sends the surplus voltage from the LED array to the base according to a preset resistance value.

5. The driver of claim 2, wherein the switch portion comprises a plurality of NPN transistors connected between the LED array and the ground,
wherein the transfer resistor group comprises a plurality of transfer resistors respectively corresponding to the plurality of NPN transistors, and sends the switching signal from the comparator to the respective base of the plurality of NPN transistors.

6. The driver of claim 5, wherein the driving part further comprises a plurality of pull-up resistors respectively connected to a base and a collector of the plurality of NPN transistors, with the exception of a single NPN transistor placed adjacent to the ground.
